(19) United States
(12) Patent Application Publication
(10) Pub. No.: US 2008/0257377 A1
(43) Pub. Date: Oct. 23, 2008

(54) FLUORIDE TREATED DENTAL FLOSS AND DISPENSER

(76) Inventor: Amanda Lynn Burrows, Oilton, OK (US)

Correspondence Address: PHILLIPS MCFALL MCCAFFREY MCVAY & MURRAH, PC, CORPORATE TOWER, 13TH FLOOR, 101 N. ROBINSON, OKLAHOMA CITY, OK, 73102, US

(21) Appl. No.: 12/106,136

(22) Filed: Apr. 18, 2008

Related U.S. Application Data
(60) Provisional application No. 60/912,841, filed on Apr. 19, 2007.

(51) Int. Cl. A61C 15/04

(52) U.S. Cl. 132/322; 132/325; 132/324

(57) ABSTRACT

A new and improved dental floss dispenser for providing dental floss pre-treated with fluoride. The dental floss dispenser comprises a container, a rotatably supported spool of dental floss mounted in the container, and a chamber containing fluoride, wherein the chamber has at least one opening for guiding the dental floss through the fluoride.

### CROSS-REFERENCE TO RELATED APPLICATIONS

Priority is claimed from provisional patent application U.S. Ser. No. 60/912,841 filed on Apr. 19, 2007, and incorporated by reference herein.

### BACKGROUND OF THE INVENTION

1. Field of the Invention

This invention relates, in general, to dental floss, and, in particular, to a dispenser for treating dental floss with fluoride.

2. Description of the Known Prior Art

Dental floss is manufactured and widely sold in thread form, and is used to clean particles of food lodged between the teeth. When food particles lodge between the teeth, they immediately begin to break down, and when they are dislodged, such as by brushing or flossing, they leave a residue of material which tends to promote tooth decay. One of the most successful methods for preventing tooth decay is the application of fluoride to tooth surfaces. Readily available commercial fluoride, such as sodium fluoride (NaF), acidulated phosphate fluoride (APF), and stannous fluoride (SnF₂), are believed to strengthen the enamel surface of the teeth by promoting the remineralization of tooth surfaces. According to the American Dental Hygienists' Association, “[f]luoride works by stopping or even reversing the tooth decay process. It keeps the tooth enamel strong and solid by preventing the loss of (and enhancing the re-attachment of) important minerals from the tooth enamel.”

While only 4 percent of Americans believe that they have gum disease, the reality is that 75 percent actually do. This number is nearly directly proportional to that percentage of Americans who do not floss on a regular basis, if at all. And in a country where it is widely recognized that prevention is the best medicine, there is obviously plenty of room for improvement. So with the number of people with gum disease being what it is, and flossing being the best means of prevention, it is not surprising that, although both are useful, flossing is recognized as being more important to oral hygiene and health than brushing teeth.

What the prior art is lacking, however, is a means to adequately provide users with a device and method for flossing while simultaneously applying fluoride to the tooth surface. Therefore, an extensive opportunity for advancements and innovation remains where the prior art fails or is deficient.

### BRIEF SUMMARY OF THE INVENTION

In view of the foregoing disadvantages inherent in the known types of apparatus, systems and methods now present in the prior art, the present invention provides a new and improved dental floss dispenser, which may be used in all applications, and specifically provides for pretreating dental floss with fluoride. As such, the general purpose of the present invention is to provide a more convenient and user-friendly device that has the advantages of the prior art while overcoming the known disadvantages.

In this respect, before explaining at least one embodiment of the invention in detail, it is to be understood that the invention is not limited in this application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore that the claims be regarded as including such equivalent constructions insofar as they do not depart from the spirit and scope of the present invention.

Accordingly, titles, headings, chapter names, classifications and overall segmentation of the application in general should not be construed as limiting. Such are provided for overall readability and not necessarily as literally defining text or material associated therewith.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide an improved dental floss that is treated with fluoride, and a method and device for dispensing such improved dental floss. Flossing with the improved fluoride treated dental floss will, in effect, deliver the fluoride directly to the interproximal tooth surfaces and the subgingival areas where many of the decay causing bacteria reside.

Another further object of the present invention is to provide a new and improved flossing device which is of a relatively simple design and thus may be easily and efficiently manufactured.

An even further object of the present invention is to provide a new and improved flossing device which is of a more durable and reliable construction than that of the existing known art.

Still another object of the present invention is to provide a new and improved flossing device which is susceptible of a low cost of manufacture with regard to both materials and labor, which accordingly is then susceptible of low prices of sale to the consuming public, thereby making such economically available to those utilizing flossing devices.

Another object of the present invention is to provide a new and improved flossing device that provides some of the advantages of the prior art, while simultaneously overcoming some of the disadvantages normally associated therewith.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference would be had to the accompanying drawings and descriptive matter in which there are illustrated preferred embodiments of the invention.

### BRIEF DESCRIPTION OF THE SEVERAL VIEWS OF THE DRAWING

The invention will be better understood and objects other than those set forth above will become apparent when consideration is given to the following detailed description thereof. Such description makes reference to the annexed pictorial illustrations, graphs, drawings, and appendices.

FIG. 1 is a perspective view of a preferred embodiment of a dental floss dispenser constructed in accordance with the present invention.

FIG. 2 is a vertical cross-sectional view of the dental floss dispenser of FIG. 1.

FIG. 3 is a perspective view of an alternative embodiment of a dental floss dispenser constructed in accordance with the present invention.

FIG. 4 is a vertical cross-sectional view of the dental floss dispenser of FIG. 3.

FIG. 5 is a perspective view of an alternative embodiment of a dental floss dispenser constructed in accordance with the present invention.

FIG. 6 is a vertical cross-sectional view of the dental floss dispenser of FIG. 5.

### DETAILED DESCRIPTION OF THE INVENTION

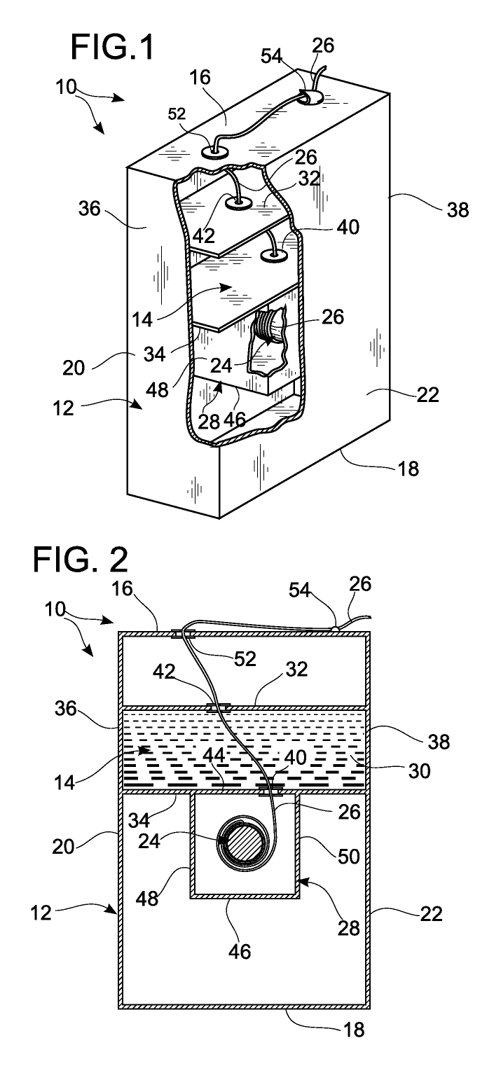

Referring now to the drawings in greater detail, FIGS. 1 and 2 show a dental floss dispenser 10 comprising a container 12. The container 12 is shown as having a chamber 14 disposed therein, preferably between an upper end 16 and a lower end 18 of the container 12. The container 12 is further shown to have a first side 20 and a second side 22 spaced a distance apart to be either as wide or wider than a conventional floss dispenser, or narrow enough to allow the dental floss dispenser 10 to fit into a conventional toothbrush holder (not shown). The dental floss dispenser 10 of the present invention is also shown to include a spool 24 of floss 26 rotatably supported in a housing 28 near the chamber 14.

The chamber 14 of the dental floss dispenser 10 may be filled with a fluid 30, preferably fluoride, and may be constructed to be in communication with the housing 28 such that floss 26 can be dispensed through the chamber 14 and impregnated with the fluid 30 contained therein. The fluoride, preferred for use in the present invention, may be in a variety of forms, including, but not limited to, a gel, liquid or powder.

The chamber 14 is formed to have an upper end 32 and a lower end 34 directly opposed to one another, and a first side 36 and second side 38 preferably congruent with the first side 20 and second side 22 of the container 12. The chamber 14 may be constructed of any material capable of holding the fluid 30 so long as there remains a minimal risk of fluid 30 leaking from the chamber 14.

The floss 26 is preferably threaded from the spool 24 through a first opening 40 in the lower end 34 of the chamber 14 where it may be impregnated with fluid 30, and then threaded through a second opening 42 in the upper end 32 of the chamber 14. Such vertical threading of the floss 26 allows for quick dispensing, and minimum tangles of the thread, as well as a lower cost of manufacturing. Furthermore, a metal guide for the floss 26 is not utilized within the chamber 14, as such guide is contemplated to be detrimental to the health of the user due to unintended chemical reactions which may occur from long term exposure to a fluid, like fluoride.

While it is shown that the first opening 40 and the second opening 42 are located on the lower end 34 and upper end 32, respectively, it is important to point out that the first opening 40 and the second opening 42 may be located on any surface of the chamber 14 such that the floss 26 is threaded through the fluid 30 contained therein. The first opening 40 and the second opening 42 are constructed to form a tight seal around the floss 26 in order to prevent fluid 30 from leaking out of the chamber 14. For example, the first opening 40 and the second opening 42 may be constructed from a rubber material in a manner similar to an air intake and release valve used for a basketball (not shown). The first opening 40 is shown to be in communication between the housing 28 and the chamber 14 such that any leakage of fluid 30 that may occur is contained in the housing 28 near the chamber 14.

The housing 28 containing the spool 24 of floss 26 is shown as having an upper end 44 congruent with the lower end 34 of the chamber 14, a lower end 46 directly opposed to the upper end 44 of the housing 28, and a first side 48 and second side 50 spaced a distance apart to allow the spool 24 of floss 26 to freely rotate within the housing 28. While it is shown that the upper end 44 of the housing 28 is congruent with the lower end 34 of the chamber 14, it is important to specify that any surface of the housing 28 may be in communication with the chamber 14 such that the floss 26 may be threaded from the housing 28 and through the chamber 14.

Further describing the dental floss dispenser 10 of FIG. 1, the upper end 16 of the container 12 is formed to include an opening 52 where the floss 26 may be removed from the container 12. A cutter 54 is placed on the upper end 16 of the container 12 and is useful for removing a segment of the impregnated floss 26. The container 12 may also include a lid (not shown) hinged at the upper end 16 of the container 12.

The container 12, chamber 14 and housing 28 are preferably fabricated out of durable plastic materials and the cutter 54 is preferably constructed of a metal or a hard plastic. However, other types of material can be used such as cardboard, wood, etc. The floss 26 is preferably fabricated of a highly absorbent, un-waxed thread.

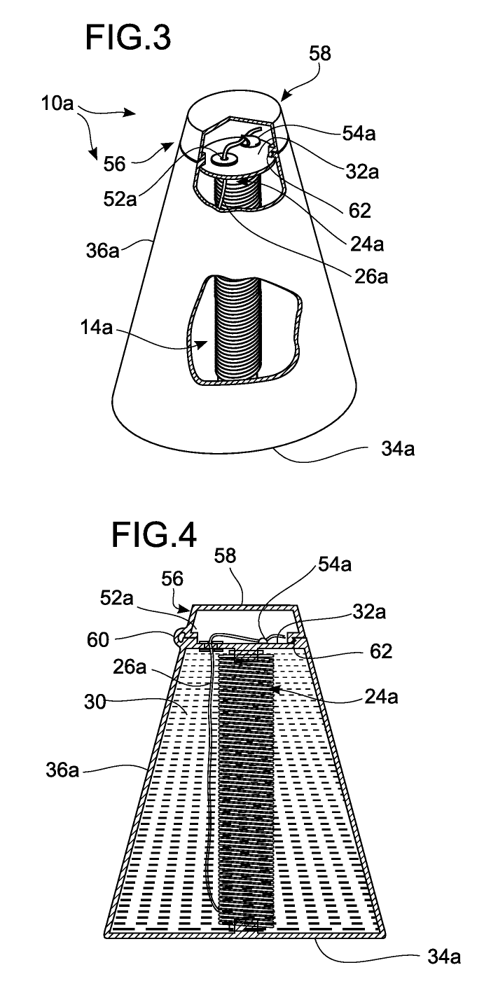

Referring now to FIGS. 3 and 4, an alternative embodiment of a dental floss dispenser 10a is shown as being frusto-conical in shape having a spool 24a of dental floss 26a disposed within a chamber 14a. The chamber 14a has an upper end 32a, a lower end 34a, and a sidewall 36a extending therebetween. The dental floss dispenser 10a further includes a dispenser cap 56 to allow convenient access to the floss 26a.

The chamber 14a is formed to contain both the fluid 30 and the spool 24a of floss 26a. The spool 24a of floss 26a is shown to extend the length of the frusto-conical shape to allow quick and easy dispensing of the floss 26a. Furthermore, it is contemplated that the submersion of the spool 24a of floss 26a within the fluid 30 allows for an improved absorption of fluid 30 on the floss 26a. In addition, the frusto-conical shape of the dental floss dispenser 10a, wherein the lower end 34a of the chamber is larger in diameter than the upper end 32a of the chamber 14a, provides a number of advantages. For example, the frusto-conical shape allows for a better weight distribution of the dental floss dispenser 10a, and allows the spool 24a of floss 26a to be wound and unwound in a vertical position rather than horizontally. However, it should be understood that a variety of shapes and arrangements are conceivable to those skilled in the art, all of which are preferred so long as the shape and arrangement is capable of carrying out the objects of the invention.

The dispenser cap 56 according to certain embodiments of the present invention comprises a lid 58. The lid 58 is preferably attached to the chamber 14a of the dental floss dispenser 10a along a plastic hinge 60. The lid 58 may be constructed to have a ridge 62 located along the periphery of the inside portion of the lid 58. The ridge 62 causes the lid 58 to snap shut when closed. When the lid 58 is closed along the hinge 60, pressure applied to the top of the dispenser cap 56 causes the ridge 62 to engage the upper end 32a of the chamber 14a, creating a friction fit. The dispenser cap 56 may include a concave surface (not shown) located on a segment of the periphery of the outside portion of the lid 58, allowing users to easily open the flip top lid 58 and gain access to the floss 26. The lid 58 is preferably opened by placing the users thumb on the concave surface and applying upward pressure to the lid 58, releasing the friction fit. However, it should be understood that the dispenser cap 56 may be constructed to include threads (not shown) as a substitute for attaching the dispenser cap 56 to the chamber 14a.

The dental floss dispenser 10a may also include plunger means (not shown) for dispensing the fluid 30 contained in the chamber 14a. Such plunger means, may include, but is not limited to, a threaded plunger attached to a stem (not shown), or an injection type plunger (also not shown) for pushing the fluid 30 towards the upper end 32a of the chamber 14a.

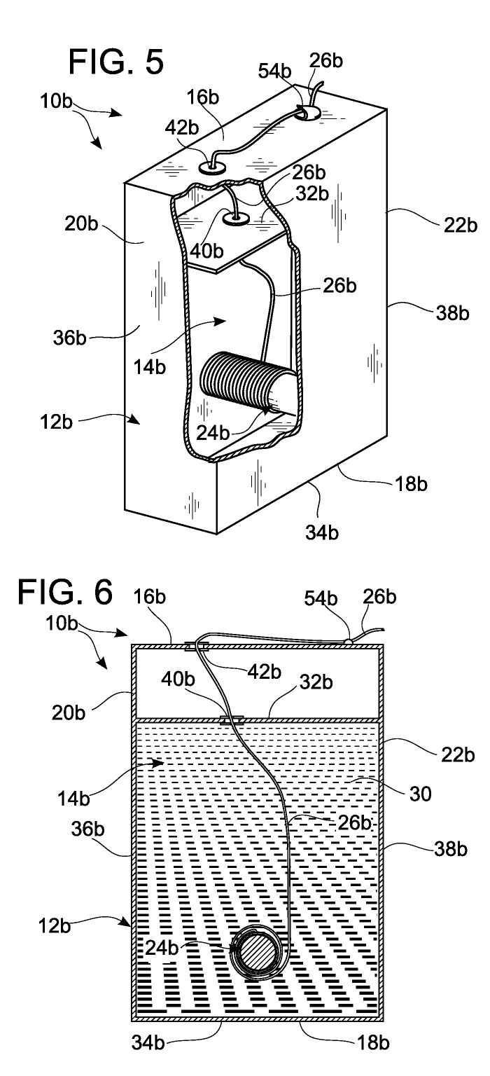

Referring now to FIGS. 5 and 6, an alternate embodiment of a dental floss dispenser 10b is shown in which a spool 24b of floss 26b is rotatably supported in a chamber 14b containing the fluid 30. The spool 24b of floss 26b rotates freely in the fluid 30, thereby allowing the floss 26b to constantly be impregnated with fluid 30. The chamber 14b containing the spool 24b of floss 26b and fluid 30 is shown to comprise an upper end 32b spaced a distance apart from an upper end 16b of the container 12b. The floss 26b is preferably threaded through a first opening 40b in the upper end 32b of the chamber 14b and a second opening 42b in the upper end 16b of the container 12b. While it is shown that the upper end 32b of the chamber 14b is separate and distinct from the upper end 16b of the container 12b, it is important to stipulate that the upper end 32b of the chamber 14b may be constructed to be congruent with the upper end 16b of the container 12b. In both instances, the user may remove the impregnated floss 26b from the container 12b, and cut a segment of the floss 26b using the cutter 54b placed on the upper end 16b of the container 12b.

While certain novel features of this invention have been shown and described in detail, it will be understood that various omissions, substitutions and changes in the forms and details of the device illustrated and in its operation can be made by those skilled in the art without departing from the spirit of the invention.

I claim:

1. An apparatus for dispensing dental floss, comprising:
a container;
a rotatably supported spool of dental floss mounted in said container; and
a chamber for containing fluoride in said container, wherein said chamber having portions defining at least one opening for guiding said dental floss through said chamber.

2. The apparatus of claim 1, further including a cutter mounted on said container.

3. The apparatus of claim 1, wherein said container being frusto-conical in shape.

4. The apparatus of claim 1, further including a dispenser cap for connection with said container.

5. The apparatus of claim 1, wherein said at least one opening including seal means for mitigating leakage of fluid from said chamber.
